(19) United States
(12) Patent Application Publication
(10) Pub. No.: US 2023/0368946 A1
(43) Pub. Date: Nov. 16, 2023

(54) SUPERCONDUCTING WIRE MATERIAL AND SUPERCONDUCTING CABLE

(71) Applicant: Kyoto University, Kyoto-shi, Kyoto (JP)

(72) Inventor: Naoyuki AMEMIYA, Kyoto-shi, Kyoto (JP)

(21) Appl. No.: 18/029,132

(22) PCT Filed: Sep. 7, 2021
(86) PCT No.: PCT/JP2021/032845

§ 371 Date: Mar. 29, 2023

(30) Foreign Application Priority Data
Sep. 30, 2020 (JP) 2020-166143

(51) Int. Cl. H01B 12/06; H01B 12/14

(52) U.S. Cl. CPC H01B 12/06; H01B 12/14

(57) ABSTRACT

Provided are a superconductor wire and a superconductor cable that have both reduced AC loss and improved robustness. The superconductor wire (10A) comprises: a plurality of superconductor layers (2) that extend in a longitudinal direction of a substrate (1) and are disposed in parallel in a transverse direction of the substrate 8 (1); at least one insulating section (3) that extend in a longitudinal direction of the substrate (1), are disposed between the plurality of superconductor layers (2, 2), and electrically insulate the plurality of superconductor layers (2, 2); and a plurality of connecting sections (4) that are disposed in the insulating sections (3) along the longitudinal direction of the substrate (1) and electrically connect adjacent superconductor layers (2, 2) in a superconducting manner; wherein the superconductor wire in a spirally wound form satisfies the following conditions:

$$\frac{1}{2} \sqrt{{P}^{2} + {( π D )}^{2}} \leq L$$

wherein D is the diameter of the spiral, P is the length of the spiral pitch along a winding axis direction, and L is the length of the insulating sections (3) along the longitudinal direction.

### TECHNICAL FIELD

The present invention relates to a superconductor wire and a superconductor cable.

### BACKGROUND ART

High-temperature superconductivity has been attracting attention as a technique for efficiently generating, transmitting, converting, using, and storing electrical energy. For example, if a wire produced using a high-temperature superconducting material (hereinafter referred to as “high-temperature superconductor wire”) or a superconductor cable formed by assembling such wires is used in an armature winding of generators or motors, the current in the armature winding can be significantly increased. This can reduce the size of the armature iron core and is expected to reduce the weight of generators and motors. The reduction of the weight of generators and motors can lead to, for example, the electrification of aircrafts and to more introduction of large-scale floating offshore wind turbines. Since the electrification of aircrafts and more introduction of wind turbines are expected to reduce CO₂ emissions, the high-temperature superconductivity technique is expected to make significant contributions to the realization of a low-carbon society.

On the other hand, when a superconductor wire is used in AC, AC loss occurs due to AC magnetic field. In general, when current flows in a superconductor or a magnetic field is applied to a superconductor, magnetic flux penetrates a superconductor in the form of a fluxoid. Under operation conditions in which a DC current or a DC magnetic field are applied, fluxoids do not move but remain stationary. On the other hand, under operation conditions in which an AC current or an AC magnetic field is applied, fluxoids must move due to changes in magnetic flux distribution at the position of the superconductor. When fluxoids move, a kind of friction is generated and what corresponds to this friction heat is AC loss in the superconductor.

When a superconductor wire is used in a superconducting state, a phenomenon called quench may occur for some reason. When quench occurs, a superconductor wire transits from a superconducting state to a normal conducting state, and devices using superconductor wires or superconductor cables, such as generators and motors, stop functioning; or, in the worst case, the devices are damaged.

This presence of AC loss in superconductor wires or superconductor cables and the low robustness of superconductor wires and superconductor cables against quench has been a bottleneck for the social implementation of devices using high-temperature superconductivity. Various methods have been proposed to solve these technical problems relating to superconductor wires and superconductor cables. For example, Patent Literature (PTL) 1 discloses a high-temperature superconductor that reduces AC loss.

### CITATION LIST

### Patent Literature

PTL 1: JP2013-535083A

### SUMMARY OF INVENTION

### Technical Problem

FIGS. 11 and 12 show schematic diagrams for explaining technical problems of a superconductor wire 90 of the prior art.

In the superconductor wire 90A (90) shown in FIG. 11(A), a superconductor layer 92 is uniformly formed on the surface of the substrate 91. AC loss is the work required to move the fluxoid 93. The longer the fluxoid 93 travels, the larger the AC loss. In the superconductor wire 90A (90), the fluxoid 93 moves across half of the width wₜ of the superconductor layer 92; therefore, AC loss is large. The reference symbol 94 indicates the movement (penetration) of the fluxoid 93. In contrast, as shown in FIG. 11(B), if the superconductor layer 92 is divided into narrow filaments with a width of w_{f} (<width wₜ) and the travelling distance of the fluxoid 93 is shortened, AC loss can be reduced. This technique is called multifilamentization. In the description below, the superconductor layer 92 that is divided into narrow filaments is referred to as superconductor filaments 92a or simply called filaments 92a.

When the magnetic field Hₑ applied perpendicularly to the superconductor layer 92 (strictly, the component Hₑ of the magnetic field applied, which is perpendicular to the superconductor layer 92; the same applies hereinafter) changes with time, eddy currents 99 flow over the width of the superconductor layer 92, 92a, as illustrated in FIGS. 11(A) and 11(B). Here, the eddy currents 99 flow in a reciprocating direction as indicated by reference symbols 99a, 99b, and the total width wₑ of the reciprocating eddy currents indicated by the reference symbols 99a, 99b is called the eddy currents width.

In superconductor wires 90A (90), 90B (90), the typical distance of movement of the fluxoid 93 is equal to one-half of the eddy currents width wₑ. Therefore, if the width wₑ of the eddy currents is wide, the AC loss is also large. If the width wₑ of the eddy currents can be narrowed, the AC loss can also be reduced.

As shown in FIG. 11(C), consider the case in which in superconductor wire 90B (90) comprising a multifilamentary superconductor layer 92a that is multifilamentized to reduce AC loss, some of the superconductor filaments 92a locally transit from a superconducting state to a normal conducting state 95 over its entire width w_{f} at a position in the longitudinal direction. If currents 96 continue to flow through filaments 92a, a large amount of heat is generated due to normal conducting resistance. Unless the currents 96 can be shunted (i.e., diverted) from the filaments 92a transited to a normal conducting state to other filaments 92a remaining in a superconducting state, then the entire superconductor wire 90B will quench due to a large amount of heat generated in the filaments transited to a normal conducting state. Since the probability of the filament 92a transiting to a normal conducting state 95 across its entire width w_{f} increases as the width w_{f} of the filament 92a becomes narrow, multifilamentization reduces robustness against quench. Accordingly, if the width w_{f} of the filament 92a is narrowed in order to reduce AC loss, robustness is reduced. The high-temperature superconductor disclosed in Patent Literature (PTL) 1 corresponds to this.

In contrast, as shown in FIG. 12(A), if, for example, a copper shunt layer 97 is combined as a conducting shunt layer on the surface of the multifilamentary superconductor layer 92a, current can flow through the conducting shunt layer even when a normal conducting state 95 locally appears in superconductor layer, and there is a possibility of preventing a reduction of robustness. However, as shown in FIG. 12(B), if the magnetic field Hₑ applied perpendicularly to the superconductor wire 90C (90) combined with a copper shunt layer 97 changes over time, coupling current 98 flows through the copper shunt layer 97 due to electromagnetic induction. The coupling current 98 first flows through the superconductor layer 92a, located on the left side of the figure, from the front to the back in the longitudinal direction, and then flows through the copper shunt layer 97 rightward in the transverse direction. Subsequently, the coupling current 98 flows through the superconductor layer 92a, located on the right side of the figure, from the back to the front in the longitudinal direction, and then flows through the copper shunt layer 97 leftward in the transverse direction, and returns to the superconductor layer 92a, located on the left side of the figure. The coupling current 98 flowing in this route inhibits the penetration of the fluxoid 93 from the space between the multifilamentary superconductor layers 92a, as seen in FIG. 11(B). In other words, as shown in FIG. 12(C), due to the influence of this coupling current 98, the fluxoid 93 penetrates not from the end of each superconductor filament 92a in the transverse direction, but from the end of the superconductor wire 90C, as indicated by the reference symbol 94, and the distance travelled by the fluxoid 93 is thus not shortened. Accordingly, if a copper shunt layer 97 is formed in order to prevent a reduction of robustness, the individual superconductor filaments 92a are coupled via the copper shunt layer 97, and AC loss cannot be reduced.

Further, when the entire superconductor wire 90C quenches, the hot spot temperature rises due to Joule loss. In order to avoid quench-induced burnout of the superconductor wire 90C, reducing the normal conducting resistance of the superconductor wire 90C is important. However, if a thick copper shunt layer 97 is formed in order to reduce the normal conduction resistance and thereby suppress the increase of the hot spot temperature, the decay of the coupling current 98 is hindered and the reduction of AC loss is inhibited.

Thus, reducing AC loss and improving robustness are inherently contradictory. For the social implementation of devices using high-temperature superconductivity, superconductor wires are required to have both reduced AC loss and improved robustness.

An object of the present invention is to provide a superconductor wire and a superconductor cable that achieve both reduction in AC loss and improvement in robustness.

### Solution to Problem

To achieve the above object, the present invention includes, for example, the following embodiments.

### Item 1

A superconductor wire comprising
a plurality of superconductor layers that extend in a longitudinal direction of a substrate and are disposed in parallel in a transverse direction of the substrate;
at least one insulating section that extends in the longitudinal direction of the substrate, is disposed between the plurality of superconductor layers, and electrically insulates the plurality of superconductor layers; and
a plurality of connecting sections that are disposed in the insulating section along the longitudinal direction of the substrate and electrically connect adjacent superconductor layers in a superconducting manner;
wherein the superconductor wire in a spirally wound form satisfies the following conditions:

$$\frac{1}{2} \sqrt{{P}^{2} + {( π D )}^{2}} \leq L$$

wherein D is the diameter of the spiral, P is the length of the spiral pitch along a winding axis direction, and L is the length of each insulating section along the longitudinal direction.

### Item 2

The superconductor wire according to Item 1, satisfying the following conditions:

L≤n·\sqrt{P²+(πD)²}≤L+2g

wherein g is the length of each connecting section along the longitudinal direction and n is a natural number of 1 or more.

Item 3

The superconductor wire according to Item 1 or 2, satisfying the following conditions:

g≥w_{f}

wherein g is the length of each connecting section along the longitudinal direction and w_{f} is the length of each superconductor layer along the transverse direction.

### Item 4

The superconductor wire according to Item 3, satisfying the following conditions:

g≥wₜ/2

wherein wₜ is the length of the superconductor wire along the transverse direction.

### Item 5

The superconductor wire according to Item 1 or 2, satisfying the following conditions:

g≤w_{f}

wherein g is the length of each connecting section along the longitudinal direction; and w_{f} is the length of each superconductor layer along the transverse direction.

### Item 6

The superconductor wire according to any one of Items 1 to 5, wherein the at least one insulating section is a plurality of insulating sections, and the plurality of insulating sections are individually disposed between the plurality of superconductor layers disposed in parallel.

### Item 7

The superconductor wire according to Item 6, wherein the plurality of connecting sections are disposed over the plurality of insulating sections disposed in parallel and positioned away from a line along the transverse direction.

### Item 8

The superconductor wire according to any one of Items 1 to 7, wherein the insulating sections are grooves that expose the substrate.

### Item 9

The superconductor wire according to any one of Items 1 to 8, further comprising a conducting layer covering the superconductor layers.

### Item 10

The superconductor wire according to Item 9, wherein the conducting layer further covers the insulating sections and the connecting sections.

### Item 11

A superconductor cable comprising
a core material, and
the superconductor wire of any one of Items 1 to 10, the superconductor wire being spirally wound along the axis of the core material.

### Advantageous Effects of Invention

According to the present invention, there can be provided a superconductor wire and a superconductor cable that achieve both reduced AC loss and improved robustness.

### BRIEF DESCRIPTION OF DRAWINGS

FIG. 1 is a diagram schematically showing the configuration of a superconductor wire 10A according to a first embodiment of the present invention.

FIG. 2 is a diagram schematically showing the configuration of a superconductor cable 20A formed using the superconductor wire 10A according to the first embodiment of the present invention.

FIG. 3 is a plan view of the superconductor wire 10A according to a first embodiment of the present invention, which is cut out on a plane including the superconductor layers 2 and the connecting sections 4. FIG. 3 illustrates an example of a case where the superconductor wire 10A does not satisfy the conditions for achieving both reduction in AC loss and improvement in robustness.

FIG. 4 is a plan view of the superconductor wire 10A according to the first embodiment of the present invention, which is cut out on a plane including the superconductor layers 2 and the connecting sections 4. FIG. 4 illustrates an example of a case where the superconductor wire 10A satisfies the conditions for achieving both reduced AC loss and improved robustness.

FIG. 5 is a schematic side view of the superconductor cable 20A according to the first embodiment of the present invention. FIG. 5 shows a state in which the superconductor wire 10A is spirally wound along the axis of the core material 9, whereby the superconductor wire 10A satisfies the conditions for achieving both reduced AC loss and improved robustness.

FIG. 6 is a diagram schematically showing the configuration of the superconductor wire 10B according to a second embodiment of the present invention.

FIG. 7 is a plan view of a superconductor wire 10B according to a second embodiment of the present invention, which is cut out along a plane including the superconductor layers 2 and the connecting sections 4. FIG. 7 illustrates a case where the superconductor wire 10B satisfies the conditions for both reducing AC loss and improving robustness.

FIG. 8 is a diagram schematically showing the configuration of the superconductor wire 10C according to a third embodiment of the present invention.

FIG. 9 is a diagram schematically showing the configuration of the superconductor wire 10D according to a modification example of the first embodiment of the present invention.

FIG. 10 is a schematic diagram of a superconductor wire 80 for explaining the meaning of terms used in the present specification.

FIG. 11 is a schematic diagram for explaining the technical problem of superconductor wire 90 of the prior art.

FIG. 12 is a schematic diagram for explaining the technical problem of superconductor wire 90 of the prior art.

### DESCRIPTION OF EMBODIMENTS

Embodiments of the present invention are described in detail below with references to the accompanying drawings. In the following description and drawings, identical reference symbols denote identical or similar elements, and redundant descriptions of the same or similar elements are thus omitted.

### Meaning of Terms

The meanings of terms used in the following description are explained. Some of the terms already used herein have been explained in their first appearance, but explanations are also repeated for the sake of clarity.

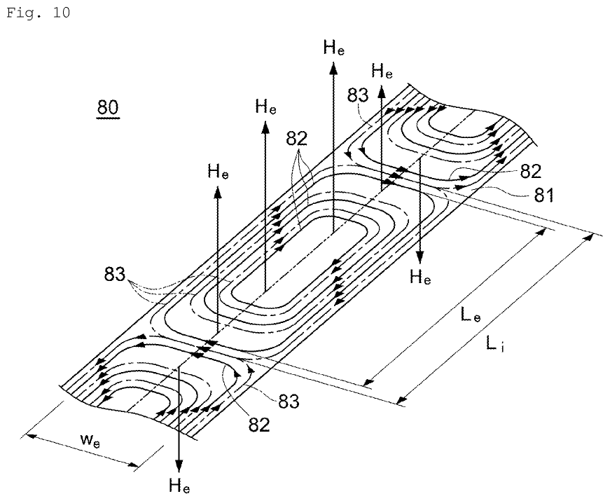

The electromotive force is, as indicated by the long-and-short dashed lines in FIG. 10, is a force that acts in the form of a loop to cause eddy currents 82 to flow in the superconductor wire 80 by electromagnetic induction when the magnetic field Hₑ applied perpendicularly to the superconductor layer 81 of the superconductor wire 80 (strictly, the component Hₑ of the magnetic field applied that is perpendicular to the superconductor layer 81) changes with time. Length Lᵢ of the longest part of the loop of the electromotive force 83 along the longitudinal direction of the superconductor wire 80 (referred to below as the “electromotive force loop length Lᵢ” for the sake of simplification) is equal to the length of the portion of the superconductor wire 80 in the longitudinal direction, where the magnetic field Hₑ is in the same direction; more precisely, the time differential dHₑ/dₜ of the magnetic field Hₑ is in the same direction. However, even if an electromotive force is generated, eddy currents cannot flow in the absence of a normal conductor or a superconductor. In this specification, the electromotive force is illustrated using long-and-short dashed lines, unless otherwise specified.

The eddy currents 82 mean currents induced in the form of a loop (vortex) in a conductor or superconductor by an electromotive force 83 caused by electromagnetic induction. The eddy currents 82 are a concept that includes both persistent eddy currents and coupled currents, which will be described later. In the present specification, the eddy currents are illustrated using solid lines, unless otherwise specified.

The length of the eddy currents is, as shown in FIG. 10, the length of the longest portion of the eddy currents 82 distributed in the superconductor wire 80 and flowing along the longitudinal direction of the superconductor wire 80 as indicated by a solid line. The length of the eddy currents is represented by the symbol Lₑ. The eddy currents 82 can only flow within the electromotive force loop length Lᵢ. That is, the eddy current length Le does not exceed the electromotive force loop length Lᵢ.

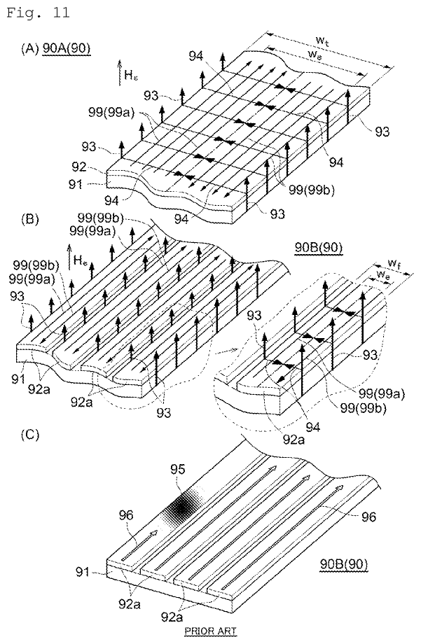

The width of the eddy currents is, as shown in FIG. 10, the length of the longest part of the eddy currents 82 distributed in the superconductor wire 80 and flowing along the transverse direction of the superconductor wire 80, as indicated by a solid line. The width of the eddy currents is represented by the symbol wₑ. With reference to FIGS. 11(A) and 11(B), the width of the eddy currents is explained. The eddy currents 82 flow in reciprocating directions as indicated by reference symbols 99a, 99b. The typical distance of travel of the fluxoid 93 is equal to one-half the eddy currents width wₑ. Accordingly, if the width wₑ of the eddy currents can be narrowed, the AC loss can be reduced.

The persistent eddy currents mean eddy currents that flow only inside a superconductor and that can be considered to be time-invariant (not decay) on practical time scales (e.g., hours to years). In the present specification, persistent eddy currents are illustrated herein using solid lines, unless otherwise specified.

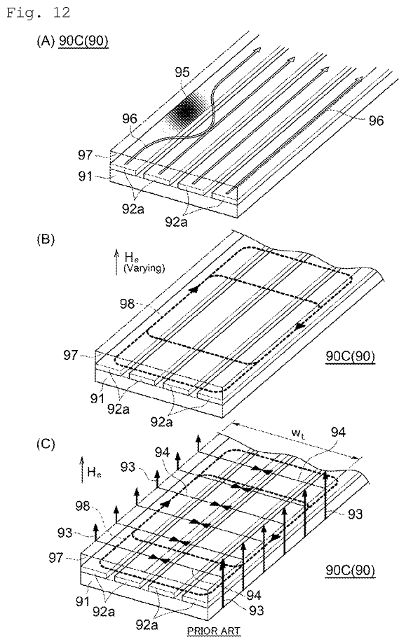

The coupling current is a type of eddy current. For example, with reference to FIG. 12(B), the coupling current is explained. The route for the coupling current 98 to flow through the superconductor wire 90C comprising a copper shunt layer 97 is as follows. The coupling current 98 first flows through a superconductor layer 92a located on the left side of the figure in the longitudinal direction from the front side to the back side. Next, the coupling current 98 flows through the copper distribution layer 97 rightward in the transverse direction. Subsequently, the coupling current 98 flows through the superconductor layer 92a located on the right side of the figure in the longitudinal direction from the back side to the front side. The coupling current 98 then flows leftward in the transverse direction through the copper distribution layer 97, and returns to the superconductor layer 92a located on the left side of the figure. Note that the coupling current 98 decays with time because the route includes the copper shunt layer 97, which is a conductor. From another viewpoint, if the fluctuation cycle (period) of the magnetic field is sufficiently longer than the coupling time constant, which is the decay time constant of the coupling current, it can be regarded as almost no flow of coupling current. In the present specification, coupled currents are illustrated using dashed lines, unless otherwise specified.

### First Embodiment

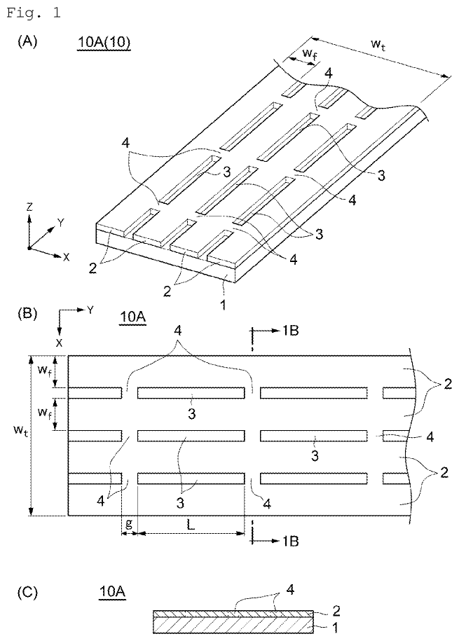

FIG. 1 is a diagram schematically showing the configuration of the superconductor wire 10A according to a first embodiment of the present invention. FIG. 1(A) is a perspective view of a superconductor wire; FIG. 1(B) is a plan view of the superconductor wire; FIG. 1(C) is a cross-sectional view of the superconductor wire taken along line 1B-1B shown in FIG. 1(B). In the illustrated embodiment, the Y-axis direction is the longitudinal direction of the superconductor wire 10A, the X-axis direction is the transverse direction of the superconductor wire 10A, and the Z-axis direction is the thickness direction of the superconductor wire 10A.

The superconductor wire 10A (10) according to the first embodiment comprises a substrate 1; a plurality of superconductor layers 2; an insulating section 3; and a plurality of connecting sections 4; wherein the superconductor wire in a spirally wound form satisfies the conditions for both reducing AC loss and improving robustness, which are explained below in detail.

The substrate 1 is formed in a tape shape using, for example, a nickel-based alloy or stainless steel. For example, the material of the substrate 1 can be Hastelloy (registered trademark). The substrate 1 is flexible, and the superconductor wire 10A is spirally wound and used.

An intermediate layer (not shown) that serves as a base for the superconductor layers 2 is formed on the surface of the substrate 1 as required. The material for the intermediate layer can be, for example, a material whose physical characteristic value, such as coefficient of thermal expansion or lattice constant, exhibits an intermediate value between the value of the substrate 1 and the value of the superconductor, which is a component for forming the superconductor layers 2. For example, the material of the intermediate layer can be LaMnO₃. In the present embodiment, an intermediate layer is formed on the surface of the substrate 1. In the description of the present specification, the substrate 1 having an intermediate layer formed thereon is inclusively referred to as the substrate 1.

The superconductor layers 2 pass currents in the superconductor wire 10A in a superconducting manner. In order to reduce AC loss, superconductor layers 2 are multifilamentized and formed on the surface of substrate 1. The superconductor layers 2 extend in the longitudinal direction of the substrate 1, and a plurality of superconductor layers 2 are disposed in parallel in the transverse direction of the substrate 1. For example, the superconductor layers 2 are formed using a REBCO high-temperature superconductor, which is a kind of ceramics. REBCO is a copper oxide superconductor having a composition formula represented by the chemical formula REBa₂Cu₃O_{7-δ} (wherein RE represents a rare earth element, such as Y, Gd, Eu, or Sm). In the description below, the multifilamentary superconductor layers 2 are called superconductor filaments 2, or briefly referred to as filaments 2 or simply called superconductor layers 2.

The insulating sections 3 extend in the longitudinal direction of the substrate 1, are disposed between a plurality of superconductor layers 2, 2, and electrically insulate the plurality of superconductor layers 2, 2. For example, in this embodiment, the insulating sections 3 are formed as grooves that expose the surface of the substrate 1 by three-dimensionally patterning the superconductor layers 2 by, for example, a known photolithography process. In this embodiment, the superconductor wire 10A has a plurality of insulating sections 3, and the insulating sections 3 are individually disposed between a plurality of superconductor layers 2, 2 disposed in parallel.

The connecting sections 4 are disposed in the insulating sections 3 along the longitudinal direction of the substrate 1 and electrically connect a plurality of adjacent superconductor layers 2, 2 in a superconducting manner. In the superconductor wire 10A, a plurality of connecting sections 4 are provided in the insulating sections 3 along the longitudinal direction of the substrate 1. In this embodiment, the connecting sections 4 are formed integrally with the superconductor layers 2 using the same superconducting material as the superconductor layers 2.

Since the connecting sections 4 electrically connect a plurality of adjacent superconductor layers 2, 2 in a superconducting manner, the superconducting shunt of the currents flowing through the superconductor layers 2 is improved, and the robustness of the superconductor wire 10A is improved. That is, even if the transition to a normal conducting state locally occurs in a superconductor layers 2 for some reason, the connecting sections 4 bridge the adjacent superconductor layers 2, 2 in a superconducting manner, and current is shunted from the superconductor layer 2 that has transited to a normal conducting state to an adjacent superconductor layer 2, whereby the quench of the entire superconductor wire 10A is prevented.

For example, the length (width) along the transverse direction of the superconductor wire 10A is about 2 mm to about 4 mm, and preferably about 1 mm to about 4 mm. The length (width) along the transverse direction of one multifilamentary superconductor layer 2 is preferably from about 0.4 mm to about 1 mm, and more preferably from about 0.1 mm to about 1 mm. For example, the thickness of the entire superconductor wire 10A including the substrate 1 and the superconductor layers 2 is in the range of about 150 μm to about 50 μm, and preferably in the range of about 50 μm to about 30 μm. Since the superconductor wire 10A is spirally wound and used, the total thickness of superconductor wire 10A including the substrate 1 and the superconductor layers 2 is more preferably less than about 30 μm.

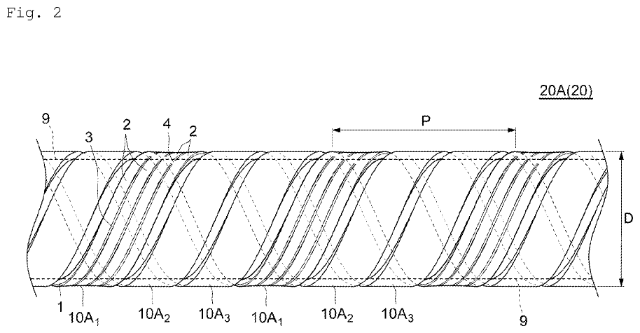

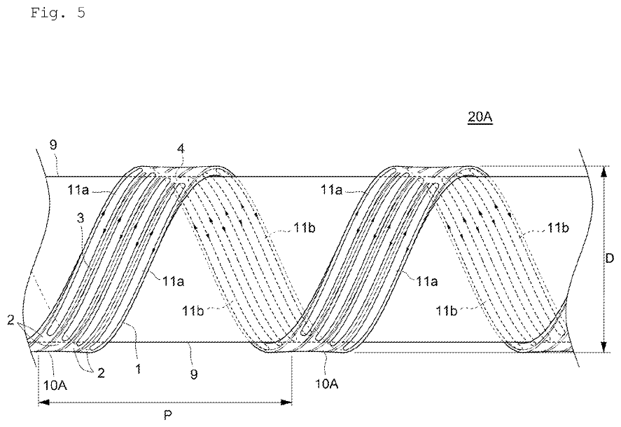

To achieve both reduced AC loss and improved robustness, the superconductor wire 10A (10) in a spirally wound form satisfies the following conditions in terms of the requirement of AC loss reduction:

$$\frac{1}{2} \sqrt{{P}^{2} + {( π D )}^{2}} \leq L$$

wherein D is the diameter of the spiral; P is the length of the spiral pitch along the winding axis direction; and L is the length of the insulating sections 3 along the longitudinal direction. The diameter D of the spiral and the length P of the spiral pitch are as illustrated in FIGS. 2 and 5 below. For example, the diameter D of the spiral is about 3 mm; the length of the spiral pitch P is about 7.5 mm; and the length L of the insulating sections 3 along the longitudinal direction is about 10 mm.

Preferably, the superconductor wire 10A (10) satisfies the following conditions in terms of the requirement of AC loss reduction:

L≤n·\sqrt{P²+(πD)²}≤L+2g

wherein g is the length of the connecting sections 4 along the longitudinal direction, and N is a natural number of 1 or more. For example, the length g of the connecting sections 4 along the longitudinal direction is about 2 mm.

The superconductor wire 10A (10) preferably satisfies the following conditions in terms of the requirement of AC loss reduction:

g≤w_{f}

wherein W_{f} is the length of the superconductor layers 2 along the transverse direction.

The superconductor wire 10A (10) preferably satisfies the following conditions in terms of the requirement of improved robustness:

g≥w_{f}

The superconductor wire 10A (10) satisfies the following conditions in terms of the requirement of improved robustness:

g≥wₜ/2

wherein Wₜ is the length of the superconductor wire 10A (10) along the transverse direction.

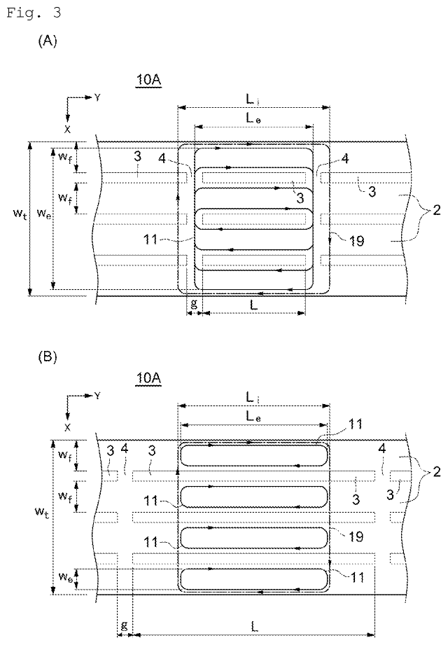

The principle of achieving both reduced AC loss and improved robustness are described later with reference to FIGS. 3 to 5.

FIG. 2 is a diagram schematically showing the configuration of a superconductor cable 20A formed using the superconductor wire 10A according to the first embodiment of the present invention.

The superconductor cable 20A (20) according to the first embodiment comprises a core material 9 and a superconductor wire 10A that is spirally wound along the axis of the core material 9.

The core material 9 is a solid cylindrical member in this embodiment. For example, the core material 9 can be stainless steel or copper.

The superconductor wire 10A (10) is wound in a spiral shape and thereby shortens the length Lᵢ of the loop of the electromotive force generated in the superconductor wire 10A (10). In this embodiment, the superconductor wire 10A is wound around the outer wall of the core material 9 in the direction in which the left-hand screw advances forward. The winding axis direction is the direction in which the left-hand screw advances forward. In the embodiment illustrated, one layer of the superconductor wire 10A (10) is spirally wound along the axis of the core material 9. In the illustrated embodiment, three superconductor wires 10A (10A₁, 10A₂, 10A₃) are spirally wound in parallel, i.e., trifilar-wound, around the outer wall of the core material 9. Of the three superconductor wires 10A₁, 10A₂, and 10A₃ shown in the figure, the structure of the superconductor wire 10A₁ is shown in detail. However, the detailed structures of the superconductor wires 10A₂ and 10A₃ are omitted and are not shown.

### Principle

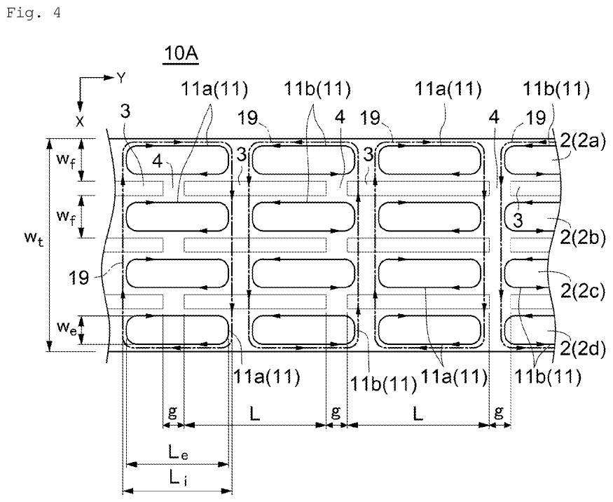

FIGS. 3 and 4 are plan views of the superconductor wire 10A according to the first embodiment of the present invention, which are cut out on a plane including the superconductor layers 2 and the connecting sections 4. FIG. 3 illustrates a case where the superconductor wire 10A does not satisfy the conditions for achieving both reduced AC loss and improved robustness. FIG. 3(A) shows an example in which the length L of the insulating section 3 is short; i.e., the interval between the connecting sections 4 is short, which improves robustness but does not reduce AC loss due to the wide persistent eddy currents 11 flowing across the entire width wₜ of the superconductor wire 10A. FIG. 3(B) shows an example in which the persistent eddy currents 11 are confined within the width w_{f} of the individual superconductor filaments 2, thus having a narrow width, and AC loss can be reduced; however, since the length L of the insulating sections 3 is long, i.e., the interval between the connecting sections 4 is long, robustness cannot be improved. FIG. 4 illustrates a case where the superconductor wire 10A satisfies the conditions for achieving both reduction in AC loss and improvement in robustness.

FIG. 5 is a schematic side view of the superconductor cable 20A according to the first embodiment of the present invention. FIG. 5 shows a state in which the superconductor wire 10A is spirally wound along the axis of the core material 9, whereby the superconductor wire 10A satisfies the conditions for achieving both reduced AC loss and improved robustness. In FIG. 5, for simplicity of illustration and explanation, only one superconductor wire 10A is illustrated. In FIG. 5, the reference symbol 11a denotes persistent eddy currents 11a that occur in the region of the superconductor wire 10A located on the front side of the core material 9 in the lateral view of the superconductor cable 20A. The symbol 11b denotes persistent eddy currents 11b that occur in the region of the superconductor wire 10A located on the back side of the core material 9.

### Reduction of AC Loss

The principle of reducing AC loss while improving robustness is explained below with reference to FIGS. 3 to 5.

To achieve AC loss reduction by multifilamentization of the superconductor layers 2, wide (large wₑ) persistent eddy currents 11 flowing across the multiple superconductor filaments 2, 2 are interrupted in the insulating sections 3 and must be controlled to be narrow (small wₑ) persistent eddy currents 11 confined within the width w_{f} of a superconductor filament 2. On the other hand, as described later, for improved robustness, the interval between the connecting sections 4, i.e., the length L of the insulating sections 3, is preferably shorter.

When the magnetic field Hₑ applied perpendicularly to the superconductor layers 2 of the superconductor wire 10A (strictly, the component Hₑ of the magnetic field applied that is perpendicular to the superconductor layer 81) changes with time, an electromotive force 19 in the form of a loop that causes eddy currents to flow in the superconductor wire 10A is induced by electromagnetic induction. The electromotive force loop length Lᵢ is determined by the distribution of the magnetic field Hₑ applied perpendicularly to the superconductor layers 2 along the longitudinal direction of the superconductor wire 10A, and is unrelated to the length L of the insulating section 3. Here, consider a case where in order to improve robustness, the connecting sections 4 are disposed at short intervals, that is, the length L of the insulating sections 3 is short and the length L of the insulating sections 3 is shorter than the electromotive force loop length Lᵢ. In this case, as indicated by a solid line in FIG. 3(A), a wide persistent eddy currents 11 continues to flow across the plurality of superconductor filaments 2, 2 via the connecting sections 4, and the AC loss reduction effect by multifilamentization of the superconductor layers 2 is not exhibited.

In contrast, as shown in FIG. 3(B), if the length L of the insulating sections 3 is longer than the electromotive force loop length Lᵢ, current is blocked by the insulating sections 3; and persistent eddy currents of a broad width in the vertical direction in the figure cannot flow across the filamentized multiple superconductor layers 2, 2, and the persistent eddy currents 11 are narrow in width (small wₑ) and confined within the width W_{f} of the individual superconductor filaments 2. This reduces AC loss.

The electromotive force loop length Lᵢ is determined by the configuration of the coil formed using a superconductor wire or a superconductor cable, and the loop length is often equal to the total length of the winding wire used to form a coil (e.g., several tens to several hundreds of meters), or several meters. Therefore, if the length L of the insulating section 3 is set to be larger than such a large length of Lᵢ in order to interrupt wide persistent eddy currents, the interval between the connecting sections 4 is too long to improve robustness.

When the connecting sections 4 are disposed at a short interval therebetween to improve robustness and wide persistent eddy currents are to be interrupted by the insulating sections 3 to reduce AC loss, it is necessary to make the electromotive force loop length Lᵢ even shorter, by some means, than the length L of the insulating sections 3, which have been shortened to satisfy the requirement of improved robustness, as shown in FIG. 4.

In the present invention, as illustrated in FIG. 5, the superconductor wire 10 is spirally wound along the axis of the core material 9, thereby making the length of the electromotive force loop Lᵢ shorter than the length L of the insulating section 3 as illustrated in FIG. 4.

When the superconductor wire 10A (10) is spirally wound along the axis of the core material 9, the length Pₜ of the superconductor wire 10A, which corresponds to the length P of the spiral pitch, can be represented by the following formula (1) by using the diameter D of the spiral.

Pₜ=\sqrt{P²+(πD)²} (1)

By spirally winding the superconductor wire 10A (10) along the axis of the core material 9, the direction of the magnetic field Hₑ applied perpendicularly to the superconductor layers 2 of the superconductor wire 10A (10) (strictly, the direction of the component Hₑ of the magnetic field applied that is perpendicular to the superconductor layers 2) is inverted for every half of the length Pₜ of the spiral pitch of the superconductor wire 10A represented by formula (1). As a result, as shown in formula (2), the length of the electromotive force loop Lᵢ, which is determined given the magnetic field, is also one-half the length Pₜ of the spiral pitch of the superconductor wire 10A, thus resulting in a significantly shorter length.

$${L}_{i} = \frac{1}{2} {P}_{t} \qquad ( 2 )$$

By spirally winding the superconductor wire 10A in this manner, the electromotive force loop length Lᵢ can be shortened as compared to the length L of the insulating section 3, which has been shortened to improve robustness. This can achieve a state of narrow (small wₑ) persistent eddy currents 11 (11a, 11b) as illustrated in FIG. 4. That is, the persistent eddy currents 11 flowing through the superconductor wire 10A are confined within the width w_{f} of the individual superconductor filaments 2 and the width wₑ of the persistent eddy currents 11 (11a, 11b) becomes narrow. The state of narrow persistent eddy currents 11 (11a, 11b) confined within the width w_{f} of the individual superconductor filament 2 is also illustrated in FIG. 5. This can reduce AC loss while improving robustness.

That is, if the length P of the spiral pitch and the diameter D of the spiral satisfy formula (3) with respect to the length L of the insulating sections 3, AC loss can be reduced.

$$\frac{1}{2} \sqrt{{P}^{2} + {( π D )}^{2}} \leq L \qquad ( 3 )$$

The conditions represented by formula (3) can also be called the condition under which no persistent eddy currents 11 are induced in the spiral ½ pitch. Formula (3) represents the lower limit of the length L of the insulating sections 3. In view of reducing AC loss, for example, the upper limit of the length L of the insulating sections 3 can preferably be 10 times, more preferably times, even more preferably 50 times, and still even more preferably 100 times, the width wₜ of the superconductor wire 10A.

In view of improving robustness, the length L of the insulating sections 3 along the longitudinal direction is preferably as short as possible, while the conditions of formula (3) are satisfied. This is because the number of connecting sections 4 that function as current diversion routes increases.

Alternatively, the upper limit of the length L of the insulating sections 3 can be, for example, represented by the following formula (4).

L≤\sqrt{P²+(πD)²} (4)

When the superconductor wire 10A is spirally wound along the axis of the core material 9 to form a superconductor cable 20A and the superconductor cable 20A is further wound around a reel such as a bobbin, the superconductor wire 10A comes into contact with the reel each time this upper limit is reached, which deteriorates cooling conditions of the superconductor wire 10A. The portion of the superconductor wire 10A where the cooling condition is deteriorated becomes the bud of a transition to a normal conducting state, which is a weak point in terms of robustness. If the upper limit of the length L of the insulating section 3 is defined by formula (4), the connecting sections 4 are provided at each interval of the upper limit. It is possible to maintain the superconducting shunt of the current flowing through the superconductor layers 2 via the connecting sections 4 at each interval of this upper limit.

Further, in relation to the conditions represented by formula (3), the conditions under which an electromotive force 19 that causes wide persistent eddy currents 11 to flow across a plurality of superconductor filaments 2, 2, via connecting sections 4 in 1 pitch of spiral is not induced in the first place can be defined under conditions in which the average transverse magnetic field relative to the spiral is constant. The formula (5) represents a more preferred condition for reducing AC loss.

L+g=n·\sqrt{P²+(πD)²} (5)

In formula (5), g represents the length of the connecting sections 4 along the longitudinal direction and n represents a natural number of 1 or more.

Formula (5) is a formula based on the assumption that the loop of the electromotive force 19 passes through the center in the longitudinal direction of the connecting sections 4. The connecting sections 4 have a length g in the longitudinal direction. If the length P of the spiral pitch and the diameter D of the spiral, with respect to a given length L of the insulating section 3 along the longitudinal direction, satisfy the following formula (6), it means that conditions under which an electromotive force 19 to cause wide persistent eddy currents 11 to flow across the plurality of multiple superconductor filaments 2, 2 via the connecting sections 4 is not induced in the first place are satisfied. When the left side and the middle side are connected by an equal sign in formula (6), the electromotive force 19 is zero for the loop through the inner edge of connecting sections 4. In formula (6), with the middle and right sides connected by the equal sign, the electromotive force 19 is zero for the loop passing through the inner edge of the connecting sections 4. Thus, in consideration of the length g of the connecting sections 4 in the longitudinal direction, the conditions for reducing AC loss represented by formula (5) can be specified as conditions represented by the following formula (6):

L≤n·\sqrt{P²+(πD)²}≤L+2g (6)

If the length g of the connecting sections 4 is shortened, the currents flowing through the connecting sections 4 can be limited in a superconducting manner; therefore, wide persistent eddy currents can be limited. The length g of the connecting sections 4 along the longitudinal direction is preferably less than or equal to the length (width) w_{f} of the superconductor layers 2 along the transverse direction.

g≤w_{f} (7)

The conditions represented by formula (7) can also be called conditions for the persistent eddy currents 11 to just saturate or not to saturate the outermost superconductor layers 2. If this condition is satisfied, at least the persistent eddy currents over the entire width wₜ, which could flow via the connecting sections 4, cannot flow in the superconductor wire 10A. In terms of reducing AC loss, formula (7) represents the upper limit of the length g of the connecting sections 4 that is determined by the relationship with the width w_{f} of one superconductor filament 2. If the lower limit of length g in formula (7) is shown, it is 0≤g. The lower limit of length g is zero.

### Principle of Erroneous Magnetic Field Reduction

With reference to FIGS. 11 and 4, the principle of erroneous magnetic field reduction is explained.

As illustrated in FIG. 11(A), in a superconductor wire 90A whose superconductor layer 92 is not multifilamentized, when the magnetic field Hₑ applied perpendicularly to the superconductor layer 92 changes with time, eddy currents 99 flow across the entire width of the superconductor layer 92 in a direction for hindering fluctuation of the magnetic field Hₑ according to Lenz's law. That is, on the left side of the figure, a bundle of eddy currents 99a flows through the superconductor layer 92 in one direction with a width of wₑ/2 from the front side to the back side in the longitudinal direction. On the right side of the figure, a bundle of eddy currents 99b flows through the superconductor layer 92 in one direction with a width of wₑ/2 from the back side to the front side in the longitudinal direction.

Such eddy currents 99 (99a, 99b) flow as persistent eddy currents in the superconductor layer 92. On the other hand, since persistent eddy currents are unexpected currents that are not taken into account when electromagnets etc. are designed, this causes an erroneous magnetic field in electromagnets that require the generation of a high-precision magnetic field, such as electromagnets for nuclear magnetic resonance (NMR) devices, electromagnets for nuclear magnetic resonance imaging (MRI), and electromagnets for particle beam accelerators.

In contrast, according to the superconductor wire 10 of the present invention, in which the superconductor layers 2 are multifilamentized and the connecting sections 4 bridge adjacent superconductor filaments 2, 2, in a superconducting manner, the erroneous magnetic field is reduced while improving robustness, as explained below.

As illustrated in FIG. 4, even in the superconductor wire 10 of the present invention, in which the superconductor layers 2 are multifilamentized, as well as in the superconductor wire 90A, in which the superconductor layer 92 is not multifilamentized, if the magnetic field Hₑ applied perpendicularly to the superconductor filament 2 changes with time, persistent eddy currents 11 flow according to Lenz's law. The persistent eddy currents flow in a confined manner within the individual superconductor filaments 2 (2a, 2b, 2c, 2d). Focusing on the directions of the persistent eddy currents 11 between adjacent superconductor filaments 2, 2, the directions of persistent eddy currents 11 that are present at positions proximate to the adjacent side are opposite to each other, and magnetic fields created by the eddy currents cancel each other out.

For example, refer to the directions of the persistent eddy currents 11a in close proximity to each other between adjacent filaments 2a, 2b. In filament 2a, the direction of the persistent eddy current 11a positioned on the side adjacent to filament 2b is to the left in the figure, whereas the direction of the persistent eddy current 11a on the side adjacent to filament 2a is to the right in the figure. Thus, the persistent eddy currents 11a, 11a that are present at positions proximate to the adjacent side between adjacent superconductor filaments 2a, 2b are in directions opposite to each other.

The persistent eddy currents 11a in close proximity to each other between adjacent filaments 2b and 2c are also in directions opposite to each other, as in the persistent eddy currents between filaments 2a, 2b described above. The same applies to the persistent eddy currents in close proximity to each other between filaments 2c and 2d. Further, the same applies to the persistent eddy currents 11b as in the persistent eddy currents 11a described above. As a result, in the example illustrated in FIG. 4, the magnetic field created by the component of the loop of persistent eddy currents 11 in filament 2a on the upper side of the figure and the magnetic field created by the component of the loop of persistent eddy currents 11 in filament 2d on the lower side of the figure remain.

In this way, in the superconductor wire 10 of the present invention, the persistent eddy currents 11 positioned proximate to the adjacent side between a plurality of adjacent superconductor filaments 2 are in directions opposite to each other, and the magnetic fields created by the persistent eddy currents 11 cancel each other out. As a result, only the magnetic fields created by the outermost component, with respect to the width of the superconductor wire 10, of the loop of the individual persistent eddy currents flowing in the superconductor filaments 2a, 2d, which are positioned at the outermost two sides with respect to the width of the superconductor wire 10 (the uppermost side and the lowermost side in the figure), remain. Therefore, according to the superconductor wire 10 of the present invention, in which the superconductor layers 2 are multifilamentized, erroneous magnetic fields generated by persistent eddy currents, which are unexpected currents not taken into consideration in designing, are reduced.

### Improvement of Robustness

To improve robustness, facilitating the shunting of currents from a superconductor filament 2 to its adjacent superconductor filament 2 is necessary. To do so, the length L of the insulating sections 3 is preferably short, that is, the interval between the connecting sections 4 is preferably short, and the length g of the connecting sections 4 is preferably longer.

If a normal conducting state locally occurs in superconductor layers 2, the maximum current that can be diverted from the normal-conducting part and flows is half the current that flows through the entire superconductor wire 10A (10). Therefore, as defined in formula (8) below, if the length g of the connecting sections 4 for shunting currents is at least half the width wₜ of the superconductor wire 10A (10), it is possible to divert the conceivable maximum current at one connecting section 4. Formula (8) shows an example of the lower limit of the length g of the connecting sections 4 determined by the relationship with the width wₜ of the superconductor wire 10A (10) in terms of improvement in robustness.

g≥wₜ/2 (8)

If the length g of the connecting sections 4 along the longitudinal direction is too short, this length g becomes a bottleneck, and the current that is diverted from the normal-conducting part and flows in from a neighboring superconductor layer 2 cannot be allowed to flow smoothly. The conditions for allowing the current to be diverted from a defect that has occurred in one superconductor filament 2 or a normal-conducting part via one connecting section 4 can be defined as in the following formula (9). Formula (9) shows an example of the lower limit of the length g of the connecting sections 4, which is determined by the relationship with the width w_{f} of one superconductor filament 2, in terms of improvement in robustness.

g≥w_{f} (9)

Needless to say, a longer length g of the connecting sections 4 is preferable in terms of shunting the current. However, in the connecting sections 4, the superconductor layers 2, 2 are not separated from each other by an insulating section 3. As a result, the width wₑ of the persistent eddy currents 11 becomes wide and AC loss locally increases. If the upper limit of the length g of the connecting sections 4 is shown in terms of improvement in robustness, the conditions represented by, for example, the following formula (10), which represents the limit at which the AC loss reduction effect by separation hardly occurs, can be considered.

From

$$g \leq \frac{1}{2} {P}_{t} , g \leq \frac{1}{2} \sqrt{{P}^{2} + {( π D )}^{2}} \qquad ( 10 )$$

In the superconductor wire 10 of the present invention, the connecting sections 4 are present between the superconductor layers 2, 2, and adjacent superconductor layers 2, 2 separated from each other are electrically connected in a superconducting manner. Therefore, for example, if a defect is present in a superconductor layer 2 or a normal-conducting part locally occurs in a superconductor layer 2 and the superconductor layer 2 thus cannot conduct current in a superconducting manner, the current can be diverted through the connecting sections 4. Therefore, unlike a conventional superconductor wire 90B, which does not comprise connecting sections 4 and has a complete electrical separation between the superconductor layers 2, or unlike a conventional superconductor wire 90C, which electrically connects the superconductor layers 2, 2 to each other by a copper shunt layer 97 in a normal conducting manner, the superconductor wire of the present invention, which comprises connecting sections 4, does not have impaired robustness even though the superconductor layer 2 is divided by multifilamentization.

### Effects

As described above, according to superconductor wire 10A and superconductor cable 20A of the first embodiment of the present invention, reduced AC loss and reduced erroneous magnetic field as well as improved robustness can both be achieved. The superconductor wire 10A according to the first embodiment comprises a plurality of connecting sections 4 electrically connecting a plurality of adjacent superconductor layers 2, 2 in a superconducting manner; and the superconductor wire in a spirally wound form satisfies the conditions for both reducing AC loss and improving robustness, as explained with reference to FIGS. 3 and 5.

In the superconductor wire 10A of the first embodiment, by shortening the length L of the insulating section 3, the connecting sections 4 electrically connect a plurality of neighboring superconductor layers 2, 2 with sufficiently short intervals in a superconducting manner. This enhances the superconducting shunt of the currents flowing through the superconductor layers 2, and improves the robustness of the superconductor wire 10A. In other words, even if a transition to the normal conducting state locally occurs in a superconductor layer 2 for some reason, the connecting sections 4 bridge the adjacent superconductor layers 2, 2 in a superconducting manner, and current is shunted from the superconductor layer 2 that has transited to a normal conducting state to its adjacent superconductor layer 2, whereby quench of the entire superconductor wire 10A is prevented.

The superconductor wire 10A according to the first embodiment is spirally wound along the axis of the core material 9, whereby the length Lᵢ of the electromotive force loop is shortened to half the length Pₜ of the superconductor wire 10A, which corresponds to the length P of the spiral pitch, thus making the length Lᵢ shorter than the length L of the insulating section 3. This reduces AC loss and also reduces erroneous magnetic field.

### Second Embodiment

The superconductor wire 10B (10) according to the second embodiment of the present invention is different from the superconductor wire 10B (10) according to the first embodiment in that the superconductor wire further comprises a conducting layer 5a (5) covering the superconductor layers 2, the insulating sections 3, and the connecting sections 4. The configuration of the superconductor wire 10B according to the second embodiment, which is described below, is the same as that of the superconductor wire 10A according to the first embodiment, unless otherwise specified. Accordingly, duplicate descriptions are omitted.

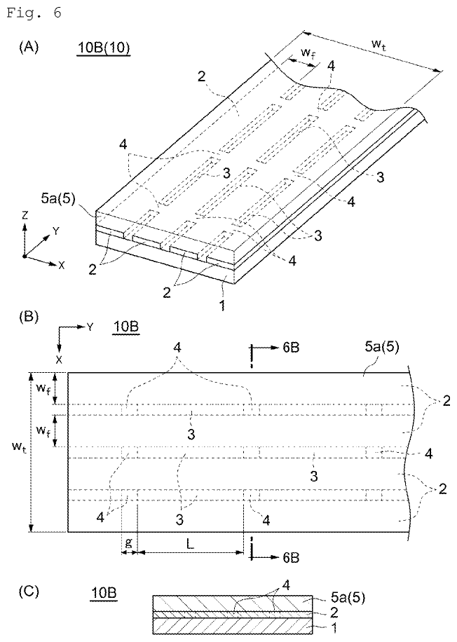

FIG. 6 is a diagram schematically showing the configuration of the superconductor wire 10B according to the second embodiment of the present invention. FIG. 6(A) is a perspective view of the superconductor wire; FIG. 6(B) is a plan view of the superconductor wire; and FIG. 6(C) is a cross-sectional view of the superconductor wire along line 6B-6B shown in FIG. 6(B).

In the second embodiment, the superconductor wire 10B (10) further comprises a conducting layer 5a (5) covering the superconductor layers 2, the insulating sections 3, and the connecting sections 4. In the embodiment illustrated, the conducting layer 5a is formed so as to cover the superconductor layers 2, the insulating sections 3, and the connecting sections 4, rather than the superconductor layers 2 alone. The conducting layer 5a functions as a shunt layer to divert the current flowing through the superconductor layers 2 in the event of an anomaly in the superconductor layers 2. For example, the conducting layer 5a is formed of copper. In the illustrated embodiment, the insulating sections 3 are formed as grooves whose bottom reaches the surface of the substrate 1. The grooves are filled with copper, which functions as a conducting layer 5a.

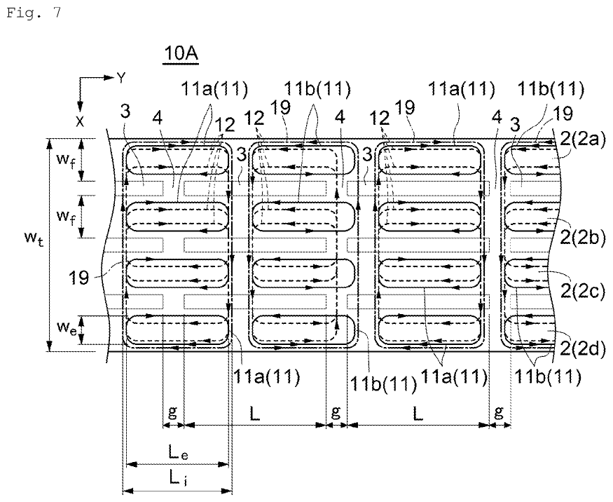

FIG. 7 is a plan view of a superconductor wire 10B according to the second embodiment of the present invention, which is cut out along a plane including the superconductor layers 2 and the connecting sections 4. FIG. 7 illustrates a case where the superconductor wire 10B satisfies the conditions for achieving both the reduction of AC loss and the improvement of robustness.

The superconductor wire 10B according to the second embodiment, which comprises a conducting layer 5a, has improved robustness as compared to the superconductor wire 10A according to the first embodiment.

The superconductor wire 10B according to the second embodiment can achieve the same AC loss reduction effect as that of the superconductor wire 10A of the first embodiment in a limited, but practically sufficient, operating frequency range.

Unlike the superconductor wire 10A according to the first embodiment, in the superconductor wire 10B according to the second embodiment, coupling currents 12 that are wide in the vertical direction of FIG. 7 flow across a plurality of superconductor layers 2 (2a, 2b, 2c, 2d), as shown by a dashed line in FIG. 7, via a conducting layer 5a provided over the superconductor layers 2, the insulating sections 3, and the connecting sections 4. As long as the coupling currents 12 do not decay, the effect of multifilamentization of the superconductor layers 2 is not exhibited and AC loss remain large.

With reference to FIG. 7, the state of coupling currents generated in the superconductor wire 10B and the state of persistent eddy currents after decay of the coupling currents are described in detail. In superconductor wire 10B in the state shown in FIG. 7, the coupling currents 12 flow across the conducting layer 5b provided over the insulating sections 3 and the width of the eddy currents with respect to the coupling currents 12 is wide in the vertical direction of the figure and goes over a plurality of superconductor layers 2 (2a, 2b, 2c, 2d). When the coupling currents 12 do not decay, AC loss is large. If the fluctuation cycle (period) of the applied magnetic field is sufficiently long as compared to the coupling time constant τ_{c}, which is the decay time constant of the coupling currents, then the coupling currents 12 decay and persistent eddy currents 11 confined within the individual superconductor filaments 2 flow. The eddy current width wₑ of the persistent eddy currents 11 confined within the superconductor filaments 2 is narrow and the AC loss is small.

The coupling currents decay depending on a coupling time constant τ_{c}, which is a ratio of the self-inductance L_{cc} and resistance R_{cc} determined by its route. The self-inductance L_{cc} is proportional to the length Lₑ of the eddy currents (coupling currents), whereas the resistance R_{cc} is inversely proportional to the length Lₑ of the eddy currents (coupling currents). Accordingly, the coupling time constant τ_{c} is proportional to the square of the length Lₑ of the eddy currents (coupling currents). Therefore, if the length Lₑ of the eddy currents (coupling currents) is long, the conducting layer 5a impairs AC loss reduction effect achieved by the multifilamentization of the superconductor layer 2.

In the second embodiment of the present invention, when the superconductor wire 10B is spirally wound like the superconductor cable 20A according to the first embodiment, the eddy current length Lₑ of the coupling currents 12 can be shortened. This can shorten the coupling time constant τ_{c}.

The fluctuation cycle (period) of the magnetic field is the reciprocal of the operating frequency. In a second embodiment, under the conditions in which the operating frequency is sufficiently smaller than the characteristic frequency f_{c}=1/(2πτ_{c}), AC loss is reduced, and the erroneous magnetic field becomes small.

In a second embodiment, in the side view of the superconductor cable, persistent eddy currents 11a are generated in the region of the superconductor wire 10B located on the front side of the core material 9, and persistent eddy currents 11b are generated in the region of the superconductor wire 10B located on the back side of the core material 9. These are similar to the first embodiment described with reference to FIGS. 4 and 5.

As in the first embodiment, the superconductor wire 10B according to the second embodiment is spirally wound along the axis of the core material 9, thus forming a superconductor cable.

### Consideration on Operating Frequency at Which AC Loss Reduction Effect is Exhibited

When the conventional superconductor wire 90C shown in FIG. 12 is used in a spirally wound form, the decay time constant (coupling time constant) τ_{c1} of the coupling current 98, which is an eddy current flowing between a plurality of superconductor layers 92a, 92a via a copper shunt layer 97, has been experimentally confirmed to be given by the following formula (11) (at a temperature of 77K):

$${τ}_{c 1} = 2.54 \times 1 {0}^{4} \cdot {( \frac{1}{2} {P}_{t} )}^{2} \cdot {t}_{Cu} \qquad ( 11 )$$

wherein t_{Cu} represents the thickness of the copper-plated copper shunt layer 97 that provides electrical conductivity between the multifilamentary superconductor layers 92a, 92a.

Suppose that when the superconductor wire 10B according to the second embodiment of the present invention is spirally wound, one side of the loop of coupled currents 12 passes through connecting sections 4. In this case, the resistance of the loop of the combined currents 12 is halved, and as shown in formula (12) below, the coupling time constant τ_{c2} is twice that of formula (11).

$${τ}_{c 2} = 5.08 \times 1 {0}^{4} \cdot {( \frac{1}{2} {P}_{t} )}^{2} \cdot {τ}_{C u} \qquad ( 12 )$$

When the coupling time constant is τ_{c} and if the characteristic frequency f_{c}=1/(2πτ_{c}) and the operating frequency is about 1/10 of the characteristic frequency f_{c}, coupling currents decay, AC loss is reduced, and erroneous magnetic fields can be reduced. That is, in the superconductor wire 10B according to the second embodiment of the present invention, which comprises connecting sections 4, if the operating frequency is less than or equal to the value of the following formula (13), an AC loss reduction effect and an effect of reducing erroneous magnetic fields caused by persistent eddy currents are both exhibited.

f_{c2}/10=1/(20πτ_{c2}) (13)

The frequency calculated by formula (13) is, for example, 500 Hz or higher, and is higher than the operating frequency of many electrical devices that operate on alternating current. In other words, most electrical devices have an operating frequency equal to or less than the value of formula (13), and satisfy the operating frequency conditions in which the superconductor wire 10 of the present invention can exhibit both the effect of reducing AC loss and the effect of reducing erroneous magnetic fields. Accordingly, the superconductor wire or the superconductor cable 20 of the present invention, which is in a robustness-improved state and further in a state of exhibiting an AC loss reduction effect and an erroneous magnetic field reduction effect, can be applied to electric devices that operate on alternating current.

### Third Embodiment

The superconductor wire 10C (10) according to a third embodiment of the present invention is different from the superconductor wire 10B (10) according to the first embodiment in that the superconductor wire 10C (10) further comprises a conducting layer 5b (5) covering the superconductor layers 2. The configuration of the superconductor wire 10C according to the third embodiment, described below, is the same as that of the superconductor wire 10A according to the first embodiment, unless otherwise specified. Accordingly, duplicate descriptions are omitted.

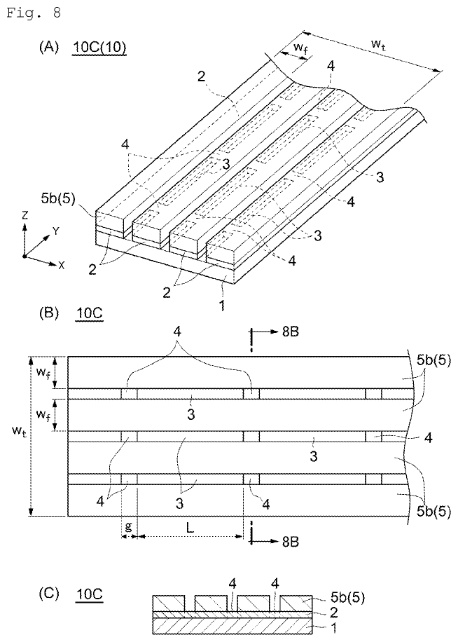

FIG. 8 is a diagram schematically showing the feature of the superconductor wire 10C according to a third embodiment of the present invention. FIG. 8(A) is a perspective view of the superconductor wire; FIG. 8(B) is a plan view of the superconductor wire; and FIG. 8(C) is a cross-sectional view of the superconductor wire along line 8B-8B shown in FIG. 8(B).

In the third embodiment, superconductor wire 10C (10) further comprises a conducting layer 5b (5). In the embodiment illustrated, the conducting layer 5b is formed so as to cover only the superconductor layers 2 without covering the insulating sections 3 or the connecting sections 4. The conducting layer 5b functions as a shunt layer to divert the current flowing through a superconductor layer 2 in the event of an anomaly in the superconductor layer 2. For example, the conducting layer 5b is formed of copper. In the illustrated embodiment, the insulating sections 3 are formed as grooves that expose the surface of the substrate 1. The conducting layer 5b is formed so as to cover only the superconductor layers 2, and the grooves are not filled with copper that functions as the conducting layer 5b.

In the third embodiment, in the side view of the superconductor cable, persistent eddy currents 11a are generated in the region of the superconductor wire 10C located on the front side of the core material 9, and persistent eddy currents 11b are generated in the region of the superconductor wire 10B located on the back side of the core material 9. These points are similar to the first embodiment described with reference to FIGS. 4 and 5. The superconductor wire 10C according to the third embodiment can achieve the same AC loss reduction effect as that of the superconductor wire 10A of the first embodiment.

The superconductor wire 10C according to the third embodiment, which comprises a conducting layer 5b, has improved robustness as compared to the superconductor wire 10A of the first embodiment. More specifically, by shunting the current from the superconductor layers 2 to the conducting layer 5b provided on the superconductor layers 2, an increase of hot spot temperature can be suppressed.

As in the first embodiment, the superconductor wire 10C according to the third embodiment is spirally wound along the axis of the core material 9, thus forming a superconductor cable.

### Other Embodiments

The present invention is described above by specific embodiments. However, the present invention is not limited to the embodiments described above.

In the embodiment described above, the superconductor wire 10 has four multifilamentary superconductor layers 2. The number of superconductor layers 2 is not limited. The superconductor wire 10 is not limited as long as at least one insulating section 3 can be disposed between a plurality of superconductor layers 2 and the superconductor wire 10 comprises at least two superconductor layers 2. Similarly, in the illustrated embodiment described above, the superconductor wire includes three insulating sections 3. The number of insulating sections 3 is not limited. The superconductor wire 10 may have at least one insulating section 3.

In the embodiment described above, the superconductor layers 2 are formed using a REBCO high temperature superconductor. The material of superconductor layers 2 is not limited. The high-temperature superconductor used for the superconductor layers 2 can be, for example, a yttrium-based high-temperature superconductor represented by the chemical formula YBa₂Cu₃O_{7-y} (wherein y represents a non-stoichiometric amount of oxygen) or a bismuth-based high-temperature superconductor. Further, the superconductor used for the superconductor layers 2 is not limited to a high-temperature superconductor whose transition temperature exceeds the temperature of liquid nitrogen (77K), and can be a superconductor whose transition temperature is lower than the liquid nitrogen temperature. In the future, superconductors having a transition temperature closer to room temperature (approximately 300K) can also be used. That is, a superconductor that exhibits superconductivity can be used as the superconductor layers 2.

In the embodiment described above, the insulating section 3 are formed, for example, as grooves that expose the surface of the substrate 1. However, the insulating sections 3 are not limited to grooves. The insulating sections 3 can be configured to be formed as a substantial member by using, for example, various insulating materials. As long as the insulating section 3 is disposed between a plurality of superconductor layers 2, 2 and electrically insulates the superconductor layers 2, 2, that is, as long as the conductivity can be divided, the insulating section 3 is not limited. The insulating section 3 can also be expressed as a conductivity divider that divides the superconducting conductivity of a plurality of superconductor layers 2, 2. The insulating sections 3 that are formed as grooves are not limited as long as they can electrically insulate a plurality of superconductor layers 2, 2. If an intermediate layer (not shown) is formed on the surface of substrate 1, insulating sections 3 may be grooves that expose the intermediate layer.

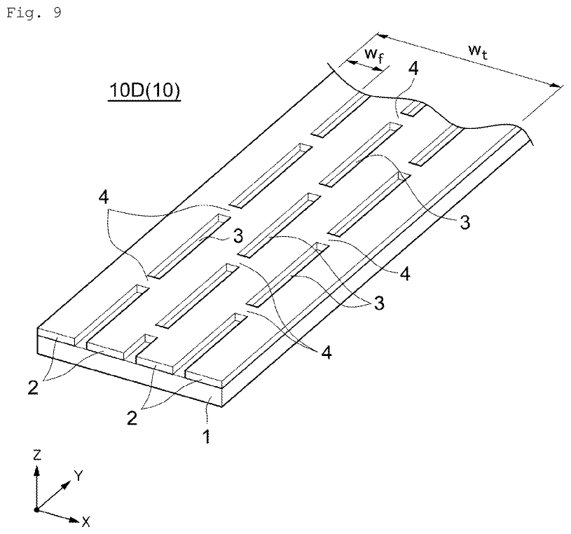

In the embodiment described above, the connecting sections 4 are formed integrally with the superconductor layers 2. However, the connecting sections 4 may be formed as a member separate from the superconductor layers 2. Further, in the embodiment described above, the connecting sections 4 are formed by using the same superconductor as the superconductor layers 2. However, the superconductor used for the connecting sections 4 and the superconductor used for the superconductor layers 2 may be different. In other words, the connecting sections 4 are not limited as long as they can electrically connect the adjacent superconductor layers 2, 2 in a superconducting manner. Further, in the embodiment described above, connecting sections 4 are aligned in the transverse direction and placed across a plurality of insulating sections 3 disposed in parallel. As illustrated in FIG. 9, the connecting sections 4 can also be disposed over a plurality of insulating sections 3 disposed in parallel and positioned away from the line along the transverse direction.

In the embodiment described above, the conducting layers 5 (5a, 5b) are formed of copper. However, the material of the conducting layers 5 are not limited to copper. The conducting layers 5 can be formed not only by using the copper mentioned as an example but also by using a material having high electrical conductivity, such as silver or gold, which is used for electrical wiring.

In the embodiment described above, the core material 9 is a solid member. However, the core material 9 can also be a hollow member. For example, if the core material 9 is a solid member, the superconductor wire 10 can be spirally wound around the outer wall of the core material 9. For example, when the core material 9 is a hollow member, the superconductor wire 10 can be spirally wound around the outer wall of the core material 9, or can be spirally wound along the inner wall of the core material 9. That is, the core material 9 is not limited as long as the superconductor wire 10 can be spirally wound along the axis of the core material 9. Further, the core material 9 can also be configured to be formed by a stranded wire formed by twisting a plurality of element wires. The element wires may or may not be insulated from each other. For example, a metallic wire, such as copper or stainless steel wire, can be used as element wires. The cross-sectional shape of the core material 9 and the element wires can be a honeycomb shape in which copper is partitioned by a high-resistance material such as a copper-nickel alloy.

In the embodiment described above, the core material 9 is a cylindrical member. However, the cross-sectional shape of the member used for the core material 9 is not limited to a circle. The cross-sectional shape of the member used for the core material 9 may be, for example, elliptical; may be a regular polygon, such as a regular hexagon or an equilateral triangle; may be rectangular; or may be a regular polygon with rounded corners or a rectangle with rounded corners. For example, in the case of a regular polygon, the cross-sectional shape of the member can more closely approximate a circle by increasing the number of corners of the regular polygon representing the cross-sectional shape of the member.

In the embodiment described above, the superconductor wire 10 is wound along the axis of the core material 9 in the direction in which the left-hand screw advances forward. The superconductor wire 10 may be wound in the direction in which the right-hand screw advances forward.

In the embodiment described above, one layer of the superconductor wire 10 is spirally wound along the axis of core material 9. The number of layers of the superconductor wire 10 spirally wound along the axis of core material 9 is not limited. Superconductor cables with increased current-carrying capacity can be produced by increasing the number of layers of the superconductor wire 10 and increasing the number of the superconductor wires 10 used for producing the cable. For example, a superconductor cable with increased current-carrying capacity can be produced by disposing n superconductor wires 10 in parallel on the same layer (for example, if n=3, then trifilar winding), spirally winding the superconductor wires 10 along the axis of the core material 9 to form a layer, and laminating a plurality of the layer thus obtained to form a multi-layer laminate. Alternatively, for example, a superconductor cable with increased current-carrying capacity can be produced by laminating a plurality of superconductor wires 10 to form a multiple-layer laminate and then spirally winding the laminate along the axis of the core material 9. Thus, when a plurality of superconductor wires 10 are to be spirally wound along the axis of the core material 9, a process comprising disposing a plurality of superconductor wires 10 on the same layer and spirally winding the superconductor wires 10 in parallel to form a layer and laminating a plurality of the layer thus obtained to form a multi-layer laminate, and a process comprising laminating a plurality of superconductor wires 10 to form a multiple-layer laminate and then spirally winding the laminate can be combined.

### DESCRIPTION OF REFERENCE SYMBOLS

1: Substrate
2 (2a, 2b, 2c, 2d): Superconductor layer
3: Insulating section
4: Connecting section
(5a, 5b): Conducting layer
9: Core material
(10A, 10B, 10C, 10D): Superconductor wire
11 (11a, 11b): Persistent eddy current
12: Coupling current
19: Electromotive force
(20A): Superconductor cable
80: Superconductor wire
81: Superconductor layer
82: Eddy current
83: Electromotive force
90 (90A, 90B, 90C): Superconductor wires of the prior art
91: Substrate
92: Superconductor layer
92a: Multifilamentary superconductor layer
93: Fluxoid
95: Normal conducting state
96: Current
97: Copper shunt layer
98: Coupling current
99 (99a, 99b): Eddy current

1. A superconductor wire comprising
a plurality of superconductor layers that extend in a longitudinal direction of a substrate and are disposed in parallel in a transverse direction of the substrate;
at least one insulating section that extends in the longitudinal direction of the substrate, is disposed between the plurality of superconductor layers, and electrically insulates the plurality of superconductor layers; and
a plurality of connecting sections that are disposed in the insulating sections along the longitudinal direction of the substrate and electrically connect adjacent superconductor layers in a superconducting manner;
wherein the superconductor wire in a spirally wound form satisfies the following conditions:
$$\frac{1}{2} \sqrt{{P}^{2} + {( π D )}^{2}} \leq L$$
wherein D is the diameter of the spiral, P is the length of the spiral pitch along a winding axis direction, and L is the length of each insulating section along the longitudinal direction.

2. The superconductor wire according to claim 1, satisfying the following conditions:
L≤n·\sqrt{P²+(πD)²}≤L+2g
wherein g is the length of each connecting section along the longitudinal direction and n is a natural number of 1 or more.

3. The superconductor wire according to claim 1, satisfying the following conditions:
g≥w_{f}
wherein g is the length of each connecting section along the longitudinal direction and w_{f} is the length of each superconductor layer along the transverse direction.

4. The superconductor wire according to claim 3, satisfying the following conditions:
g≥wₜ/2
wherein wₜ is the length of the superconductor wire along the transverse direction.

5. The superconductor wire according to claim 1, satisfying the following conditions:
g≤w_{f}
wherein g is the length of each connecting section along the longitudinal direction; and w_{f} is the length of each superconductor layer along the transverse direction.

6. The superconductor wire according to claim 1, wherein the at least one insulating section comprises a plurality of insulating sections, and the plurality of insulating sections are individually disposed between the plurality of superconductor layers disposed in parallel.

7. The superconductor wire according to claim 6, wherein the plurality of connecting sections are disposed over the plurality of insulating sections disposed in parallel and positioned away from a line along the transverse direction.

8. The superconductor wire according to claim 1, wherein the insulating sections are grooves that expose the substrate.

9. The superconductor wire according to claim 1, further comprising a conducting layer covering the superconductor layers.

10. The superconductor wire according to claim 9, wherein the conducting layer further covers the insulating sections and the connecting sections.

11. A superconductor cable comprising
a core material, and
the superconductor wire of claim 1, the superconductor wire being spirally wound along the axis of the core material.
